(19) United States
(12) Patent Application Publication
(10) Pub. No.: US 2013/0248011 A1
(43) Pub. Date: Sep. 26, 2013

(54) FAUCET CONTROL VALVE

(71) Applicant: CHAN-LONG KUO, Chang Hwa (TW)

(72) Inventor: CHAN-LONG KUO, Chang Hwa (TW)

(73) Assignee: GUO YUAN HARDWARE CO., LTD., Chang Hwa (TW)

(21) Appl. No.: 13/425,549

(22) Filed: Mar. 21, 2012

(51) Int. Cl. F16K 11/00

(52) U.S. Cl. 137/315.09

(57) ABSTRACT

A faucet control valve, which is consist of an upper case, a lever, a holder, an upper valve sheet, a lower valve sheet and a base, wherein a flat bottom part is set on the bottom of the base, at least an inlet channel and an outlet channel are set inside the base, the inlet channel is extended down to the flat bottom part and a first water intake is set on it for directly inserting the end of an inlet tube. By the structure, the purpose of conveniently assembling, simplifying the process and reducing material costs can be achieved.

### BACKGROUND OF THE INVENTION

1. Field of the Invention

The invention relates to a faucet control valve and, more particularly, to a faucet control valve for simplifying assembly, to thereby effectively provide the purpose of conveniently assembling, simplifying the process and reducing material costs.

2. Description of Related Art

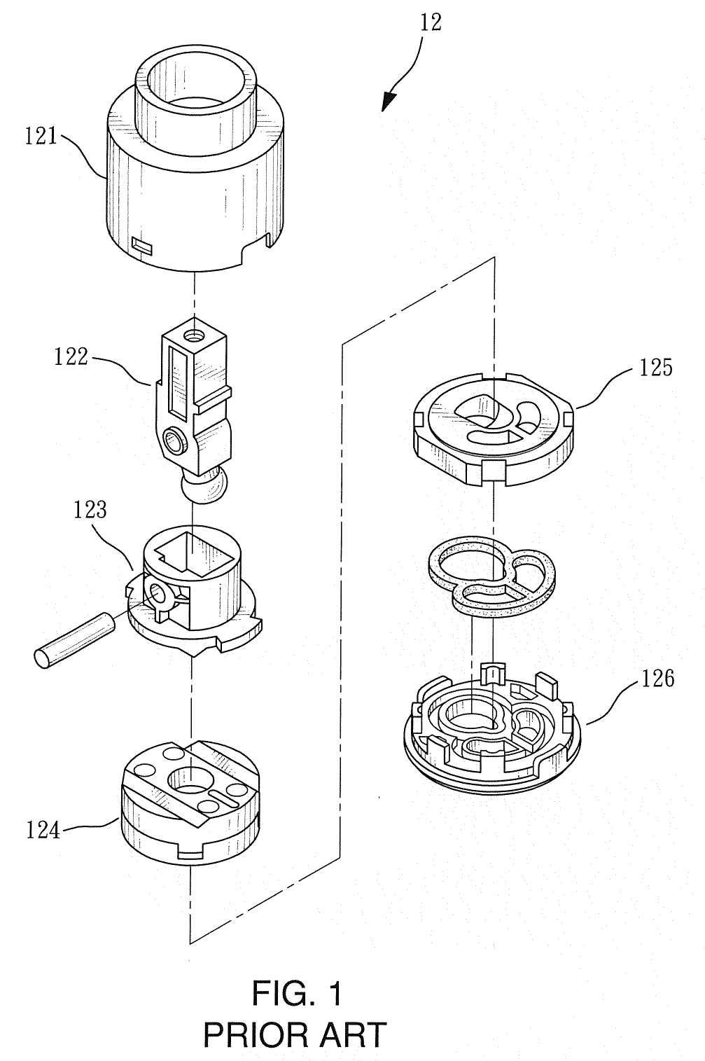

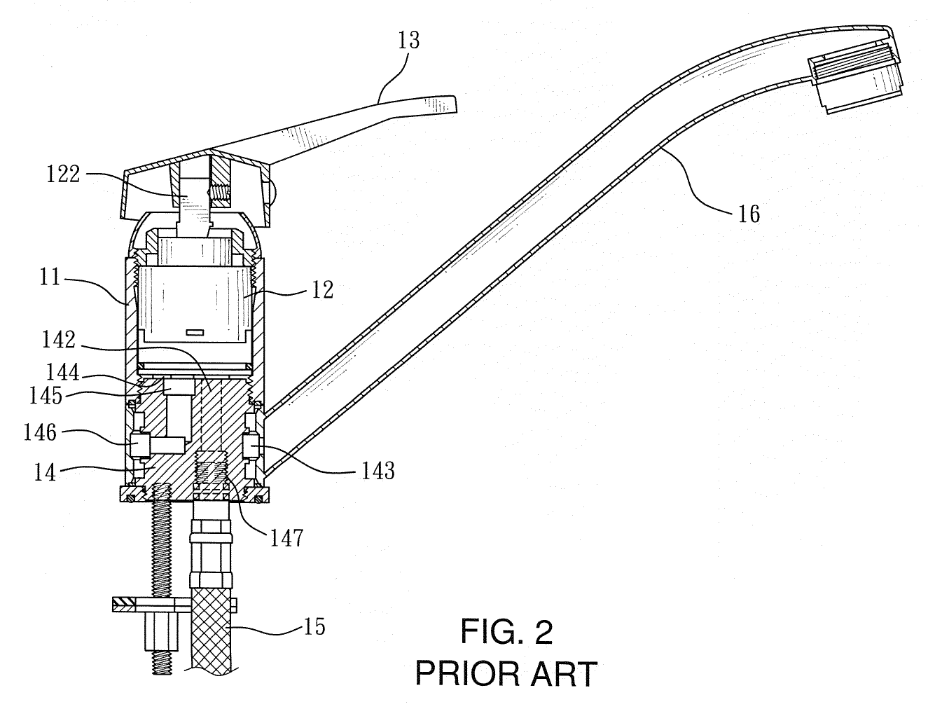

The structure of a control valve 12 of a general faucet (as shown in FIG. 1), which is consist of an upper case 121, a lever 122, a holder 123, an upper valve sheet 124, a lower valve sheet 125 and a base 126, is used for installing inside the faucet body 11 (as shown in FIG. 2) for controlling water flowing in and out. The assembly inside the faucet is mainly installing the control valve 12 inside the body 11, the lever 122 on the top of the control valve 12 is connected to a handle 13 for operating the control of water flowing in and out. The bottom of the control valve 12 is attached on a valve body seat 14. At least a water inlet hole 142, a water outlet hole 145 and at least a positioning hole 144 are set on the top side of the valve body seat 14. A lateral hole 146 is set on the middle section of the valve body seat 15 and connected to the water outlet hole 145, and an outlet 143 is set on the outlet end of the lateral hole 146. An internal thread section 147 is set on the lower end of the water inlet hole 142 of the valve body seat 14 for an inlet tube 15 screwing on. Basically, there are no problems in using the abovementioned structure, but the production of the valve body seat 14 is truly troubled the industry. Since the volume of the valve body seat 14 is large, it consumes a large amount of copper and is produced through complicated processes, such as cutting, tapping and drilling. In the process, if there is any error occurred in one of the holes, the valve body seat 14 becomes a waste. In Recent years, especially under the condition of rising raw materials price, defective products produced in manufacturing process have become a heavy burden on manufacturing costs. The widely used control valve 12 structure cannot be connected to the inlet tube 15 if not use the valve body seat 14 for supporting the control valve 12, the industry is deeply troubled by rising material costs and complicated machining process.

### SUMMARY OF THE INVENTION

In view of the drawbacks of the conventional structure, the inventor provides a faucet control valve, namely, the object of the invention is to provide a control valve structure for simplifying assembly of faucets, to thereby achieve the purpose of conveniently assembling, simplifying the process and reducing material costs.

To achieve the object, the faucet control valve according to the present invention is consist of an upper case, a lever, a holder, an upper valve sheet, a lower valve sheet and a base, wherein:

the upper case, which has an inner cavity with a downward opening, a boss is set on the top of the upper case, an aperture is set on the boss and connected to the inner cavity;

the lever, which has a allocated block set on its bottom, the upper section of the lever is passed through the aperture of the boss of the upper case;

the holder, which has a fitting hole concavely set on the top of its holder body for placing the lever inside, and a cover part is set on the bottom of the holder;

the upper valve sheet, which is a sheet body, is attached on the cover part of the holder, a positioning hole is set in the center of the upper valve sheet for the allocated block of the lever embedding in, and the upper valve sheet is shifted when the allocated block is moved;

the lower valve sheet, the top of the lower valve sheet is attached to the bottom of the upper valve sheet, and at least an inlet through hole and an outlet through hole are set on the valve sheet;

the base, which is fixedly combined with the upper case, the top of the base is attached to the bottom of the lower valve sheet;

the feature is:

a flat bottom part is set on the bottom of the base, at least an inlet channel and an outlet channel are set inside the base, the lower end of the inlet channel is extended down to the flat bottom part and a first water intake is set on it for inserting the end of an inlet tube, the upper end of the inlet channel is extended up to the top of the base and a first water outtake is set on it; the upper end of the outlet channel is extended up to the top of the base and a second water intake is set on it, the end of the outlet channel is extended to one side of the base and a second water outtake is set on it.

The above control valve, wherein an internal thread section is set near the first water intake inside the inlet channel for screwing an external thread section on the end of the inlet tube.

The above control valve, wherein at least an embedded gap is surrounded set on the circumference edge of the bottom of the inner cavity of the upper case.

The above control valve, wherein at least a convex rub is surrounded set on the circumference edge of the top of the base.

The above control valve, wherein a first seal ring and a second seal ring are respectively embedded below and above the location of the second water outtake on the circumference edge of the base.

The above control valve, wherein the second water outtake set on the end of the outlet channel is set on the flat bottom part, and an internal thread section is set near the second water outtake for an external thread section set on one end of an outlet tube, and an outlet head is set on the other end of the outlet tube.

The above control valve, wherein the second outtake set on the end of the outlet channel is set on one side of the base and located on the front side of the circumference of the base.

### BRIEF DESCRIPTION OF THE INVENTION

The detail structure, the applied principle, the function and the effectiveness of the present invention can be more fully understood with reference to the following description and accompanying drawings, in which:

FIG. 1 is a three-dimensional exploded diagram of a conventional control valve;

FIG. 2 is a schematic diagram of one embodiment according to a conventional faucet;

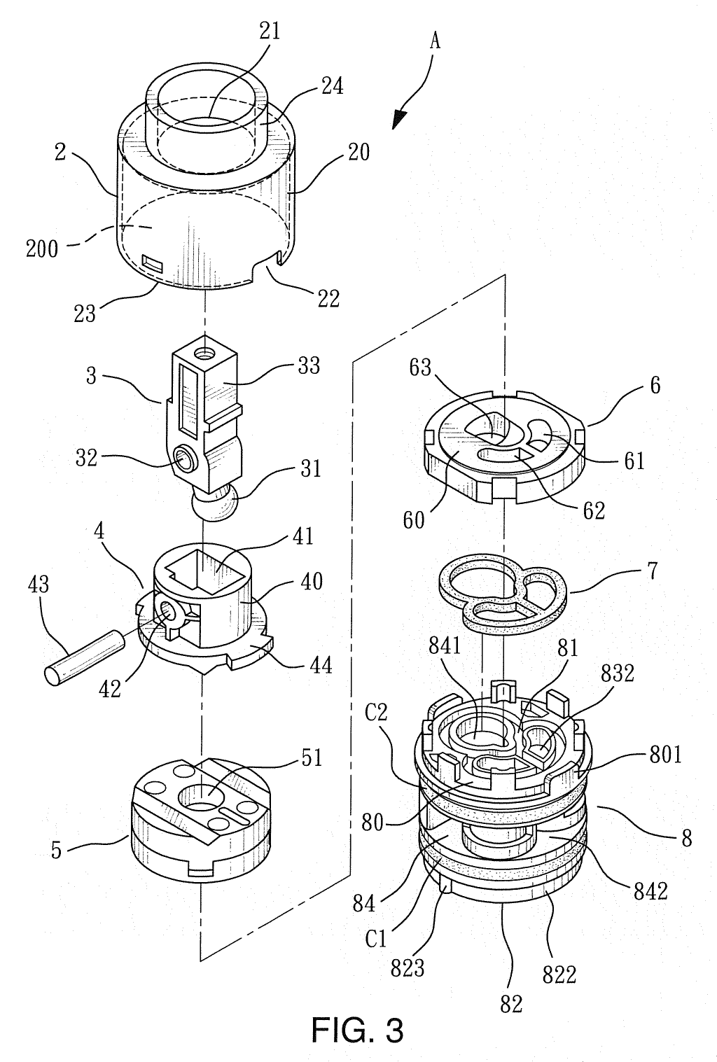

FIG. 3 is a three-dimensional exploded diagram according to the present invention;

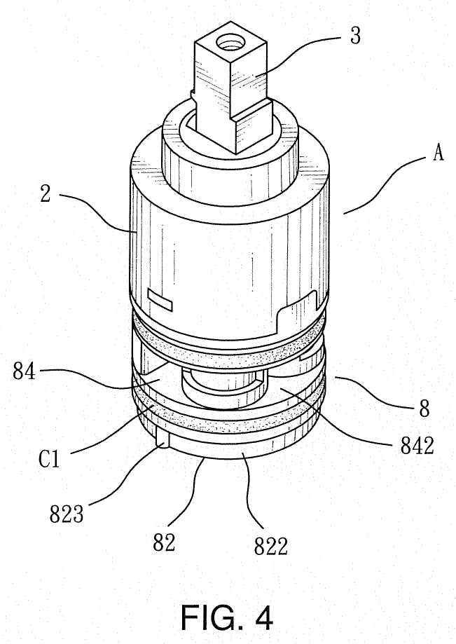

FIG. 4 is a three-dimensional diagram according to the present invention;

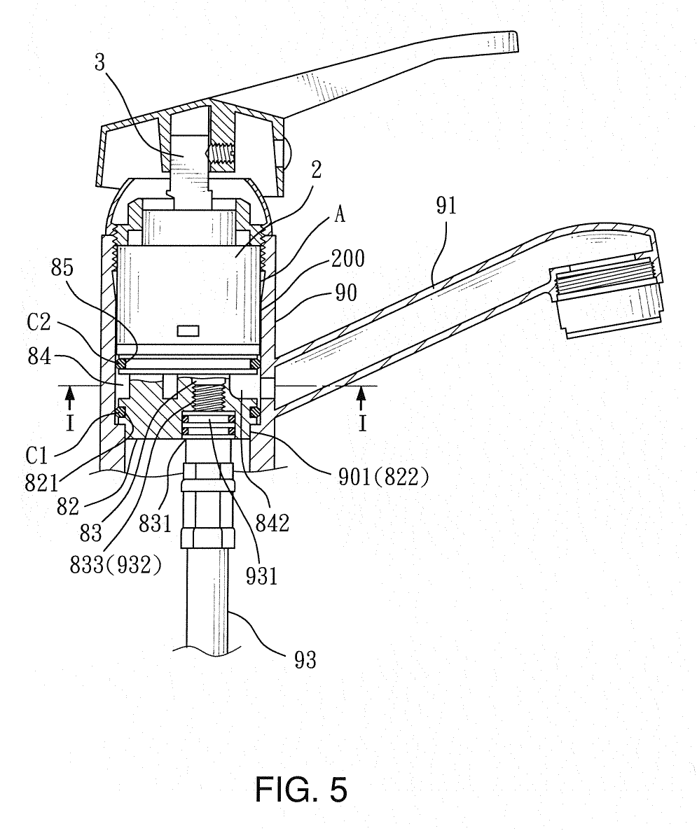

FIG. 5 is a schematic diagram of one embodiment according to the present invention;

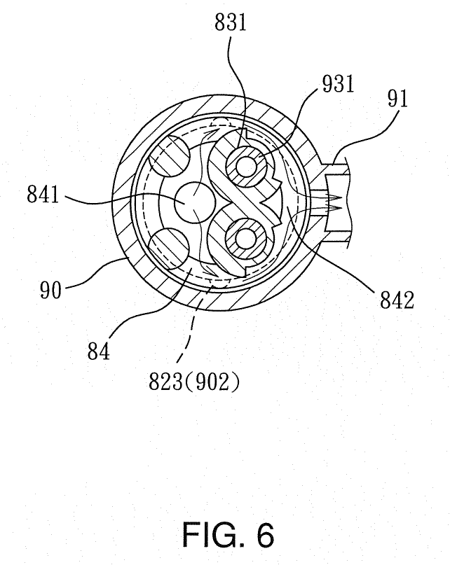

FIG. 6 is a cross-sectional view along the cutting line I-I in FIG. 5 according to the present invention;

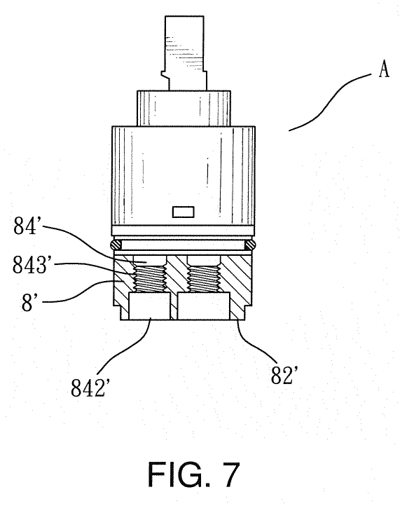

FIG. 7 is a cross-sectional view of another embodiment according to the control valve of the present invention; and

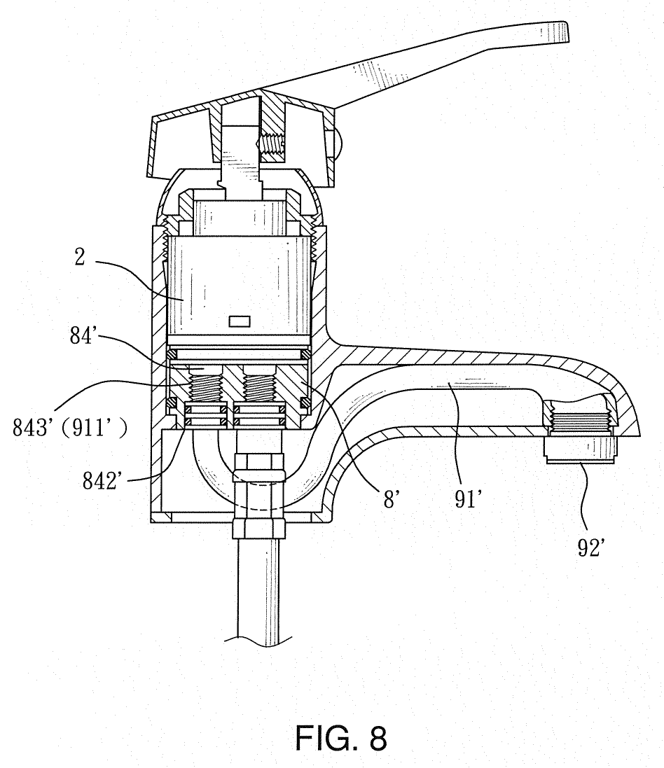

FIG. 8 is a schematic diagram of the embodiment in FIG. 7 according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

Please refer to FIG. 3 and FIG. 4, the faucet control valve A of the present invention is consist of an upper case 2, a lever 3, a holder 4, an upper valve sheet 5, a lower valve sheet 6 and a base 8, wherein:

the upper case 2, which has an inner cavity 200 with a downward opening on the case 20, at least an embedded gap 22 is surrounded set on the circumference of the bottom 23 of the inner cavity 200, a boss 24 is set on the top of the case 20, an aperture 21 is set on the boss 24, and the aperture 21 is connected to the inner cavity 200;

the lever 3, which has a allocated block 31 set on its bottom, an insertion hole 32 is horizontally set in the middle section of the lever 3, the upper section 33 of the lever 3 is passed through the aperture 21 of the boss 24 of the upper case 2;

the holder 4, which has a fitting hole 41 concavely set on the top of its holder body 40 for placing the lever 3 inside, a bolt hole 42 is set on the side edge of the base 40 for a bolt 43 inserting in the insertion hole 32, and a cover part 44 is set on the bottom of the holder 4;

the upper valve sheet 5, which is a sheet body, is attached on the cover part 44 of the holder 4, a positioning hole 51 is set in the center of the upper valve sheet 5 for the allocated block 31 of the lever 3 embedding in, and the upper valve sheet 5 is shifted when the allocated block 31 is moved;

the lower valve sheet 6, whose top 60 is attached to the bottom of the upper valve sheet 5, and at least an inlet through hole 61 (62) and an outlet through hole 63 are set on the valve sheet 6;

the base 8, whose top 80 is attached to the bottom of the lower valve sheet 6, at least a convex rub 801 is surrounded set on the circumference edge of the top 80, the convex rib 801 is embedded in the embedded gap 22 of the upper case 2 for fixedly combining the base 8 with the upper case 2;

the feature is:

a flat bottom part 82 is set on the bottom of the base 8, at least an inlet channel 83 and an outlet channel 84 are set inside the base 8 (please refer to FIG. 3, FIG. 4, FIG. 5 and FIG. 6), the lower end of the inlet channel 83 is extended down to the flat bottom part 82 and a first water intake 831 is set on it for inserting the end 931 of an inlet tube 93, the upper end of the inlet channel 83 is extended up to the top 80 of the base 8 and a first water outtake 832 is set on it; the upper end of the outlet channel 84 is extended up to the top 80 of the base 8 and a second water intake 841 is set on it, the end of the outlet channel 84 is extended to one side of the base 8 and a second water outtake 842 is set on it.

The above faucet control valve A, wherein an embedded slot 81 is surrounded set outside the hole edge of the first water outtake 832 and the second water intake 841 on the surface of the top 80 of the base 8, the embedded slot 81 is provided for a wearing ring 7 embedded in to stop leaking of water flowing in and out.

The above faucet control valve A, wherein the second water outtake 842 set on the end of the outlet channel 84 is set on one side of the base 8, and the ideal location is on the front side of the circumference of the base 8.

The above inlet channel 83, wherein an internal thread section 833 is set near the first water intake 831 for screwing an external thread section 932 on the end 931 of the inlet tube 93.

The above control valve A, wherein a first seal ring C1 and a second seal ring C2 are respectively embedded below and above the location of the second water outtake 842 on the circumference edge of the base 8. Wherein, the first seal ring C1 is embedded in a first groove 821 set on the circumference of the flat bottom part 82 of the base 8, the second seal ring C2 is embedded in a second groove 85 set on the upper side of the second water outtake 842 of the base 8 (the second groove 85 may also be set on the circumference of the case 20 of the upper case 2). By the installation of the first seal ring C1 and the second seal ring C2, water may not be oozed upward or downward when setting up the control valve A inside the faucet body 90 (please refer to FIG. 5 simultaneously).

By the composition of the above structure, when setting up the control valve A inside the faucet body 90, since the design of the flat bottom part 82 of the control valve A, the inlet tube 93 may be directly inserted, and the flat bottom part 82 is sealed for preventing water flowing downward. Also, the flat bottom part 82 may support the installation of the inlet tube 93, thus, the valve body seat needed in the conventional control valve may be saved, the inconvenience in assembling the valve body seat may be reduced and the burden of material cost may be effectively decreased.

The above flat bottom part 82 of the present invention, wherein the lower edge is shrunk as a first limiting edge 822 with the diameter smaller than the diameter of the circumference of the base 8 of the control valve A. And, a second limiting edge 901 is set corresponding to the location of the first limiting edge 822 on the faucet body 90 for limiting the location of the control valve A installing inside the faucet body 90. Simultaneously, at least a positioning rib 823 may be set on the circumference of the flat bottom part 82 for embedding in a corresponding positioning gap 902 inside the faucet body 90, thus the control valve A may be accurately positioned inside the faucet body 90 (please refer to FIG. 6).

Please refer to FIG. 5 and FIG. 6, when needing water, adjusting the lever 3 to the water-outlet position, at the time, water flows into the inlet channel 83 through the inlet tube 93 and passes the inlet through hole 61 (62), water flow turns to flow into the outlet channel 84 from the outlet through hole 63, and then flows to the outlet tube 91 from the water outtake 842 for providing water.

Another embodiment of the present invention is shown in FIG. 7 and FIG. 8, wherein the second water outtake 842′ set on the end of the outlet channel 84′ inside the base 8′ of the control valve A is set on the flat bottom part 82′, an internal thread section 843′ is set on the outlet channel 84′ near the second water outtake 842′ for screwing an external thread section 911′ set on one end of an outlet tube 91′, and an outlet head 92′ is set on the other end of the outlet tube 91′. The structure is convenient for the outlet tube 91′ with a joint pipe installation, to thereby provide the assembly of non-casting faucet body.

I claim:

1. A faucet control valve, which is consist of an upper case, a lever, a holder, an upper valve sheet, a lower valve sheet and a base, wherein:
the upper case, which has an inner cavity with a downward opening, a boss is set on the top of the upper case, an aperture is set on the boss and connected to the inner cavity;
the lever, which has a allocated block set on its bottom, the upper section of the lever is passed through the aperture of the boss of the upper case;
the holder, which has a fitting hole concavely set on the top of its holder body for placing the lever inside, and a cover part is set on the bottom of the holder;
the upper valve sheet, which is a sheet body, is attached on the cover part of the holder, a positioning hole is set in the center of the upper valve sheet for the allocated block of the lever embedding in, and the upper valve sheet is shifted when the allocated block is moved;
the lower valve sheet, the top of the lower valve sheet is attached to the bottom of the upper valve sheet, and at least an inlet through hole and an outlet through hole are set on the valve sheet;
the base, which is fixedly combined with the upper case, the top of the base is attached to the bottom of the lower valve sheet;
the feature is:
a flat bottom part is set on the bottom of the base, at least an inlet channel and an outlet channel are set inside the base, the lower end of the inlet channel is extended down to the flat bottom part and a first water intake is set on it for directly inserting the end of an inlet tube, the upper end of the inlet channel is extended up to the top of the base and a first water outtake is set on it; the upper end of the outlet channel is extended up to the top of the base and a second water intake is set on it, the end of the outlet channel is extended to one side of the base and a second water outtake is set on it.

2. The faucet control valve as claimed in claim 1, wherein an internal thread section is set near the first water intake inside the inlet channel for screwing an external thread section on the end of the inlet tube.

3. The faucet control valve as claimed in claim 1, wherein at least an embedded gap is surrounded set on the circumference edge of the bottom of the inner cavity of the upper case.

4. The faucet control valve as claimed in claim 1, wherein at least a convex rub is surrounded set on the circumference edge of the top of the base.

5. The faucet control valve as claimed in claim 1, wherein a first seal ring and a second seal ring are respectively embedded below and above the location of the second water outtake on the circumference edge of the base.

6. The faucet control valve as claimed in claim 1, wherein the second water outtake set on the end of the outlet channel is set on the flat bottom part, and an internal thread section is set near the second water outtake for an external thread section set on one end of an outlet tube, and an outlet head is set on the other end of the outlet tube.

7. The faucet control valve as claimed in claim 1, wherein the second outtake set on the end of the outlet channel is set on one side of the base and located on the front side of the circumference of the base.
